(19) United States
(12) Patent Application Publication
(10) Pub. No.: US 2003/0231580 A1
(43) Pub. Date: Dec. 18, 2003

(54) Method and device to compute the discriminant function of signals modulated with one or more subcarriers

(76) Inventors: Nicolas Martin, Bourg Les Valence (FR); Blandine Coatantiec, Bourg Les Valence (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/301,815

(22) Filed: Nov. 22, 2002

(30) Foreign Application Priority Data
Nov. 23, 2001 (FR) 01 15192

(51) Int. Cl. H04J 11/00

(52) U.S. Cl. 370/203; 370/335

(57) ABSTRACT

The invention concerns satellite radionavigation, especially GPS (Global Positioning System), Galileo, GLONASS (Global Navigation Satellite System, Russian definition) type satellite radionavigation, etc.

This invention makes the receiver for Code Only mode in tracking more robust not only with BOC modulation but with any modulation involving one or more subcarriers.

The invention proposes a method to compute the discriminant function of signals modulated by modulation with one or more subcarriers, wherein it comprises elimination of said subcarrier(s).

In addition, the invention concerns a device to track BOC modulated satellite radionavigation signals. It comprises a discriminant function computation device implementing the discriminant function computation method eliminating said subcarrier(s). The discriminant function is used by the code loop of said signal tracking device.

### START

The invention concerns satellite radionavigation, especially GPS (Global Positioning System), Galileo, GLONASS (Global Navigation Satellite System, Russian definition) type satellite radionavigation, etc.

### STATE OF THE ART

Satellite radionavigation is used to obtain the position of the receiver by a method similar to triangulation. The distances are measured using signals sent by satellites.

The signals transmitted by the satellites are formed by modulation of the signal carrier with a spreading code. Thus, the satellite signals provide two types of measurement in order to localise the receiver. In addition, carrier modulation by a spreading code extends the spectrum in the spectral band, which makes the system more resistant to jamming. And, moreover, this provides a means of dissociating the satellites (by using a different code for each satellite).

The first type of distance measurement by satellite radionavigation is a traditional measurement based on the carrier of the received signal. Measurements based on the carrier phase are accurate but ambiguous. The receiver can in fact evaluate the number of wavelengths between the satellite and the receiver to an accuracy of one wavelength.

The second type of distance measurement uses the code of the received signal. Measurements based on the code, unlike those based on the carrier, are not ambiguous since the receiver can evaluate the integer number of code periods between the satellite and the receiver. However, measurements based on the code are much less accurate than those based on the phase.

To perform these two types of measurement, the receiver acquires and tracks the received signal. To do this, it generates replicas of the code and the carrier, called local, which it correlates with the received signal. Since the code information and the carrier information are not coherent, the generations of code and carrier replicas are slaved by two separate loops.

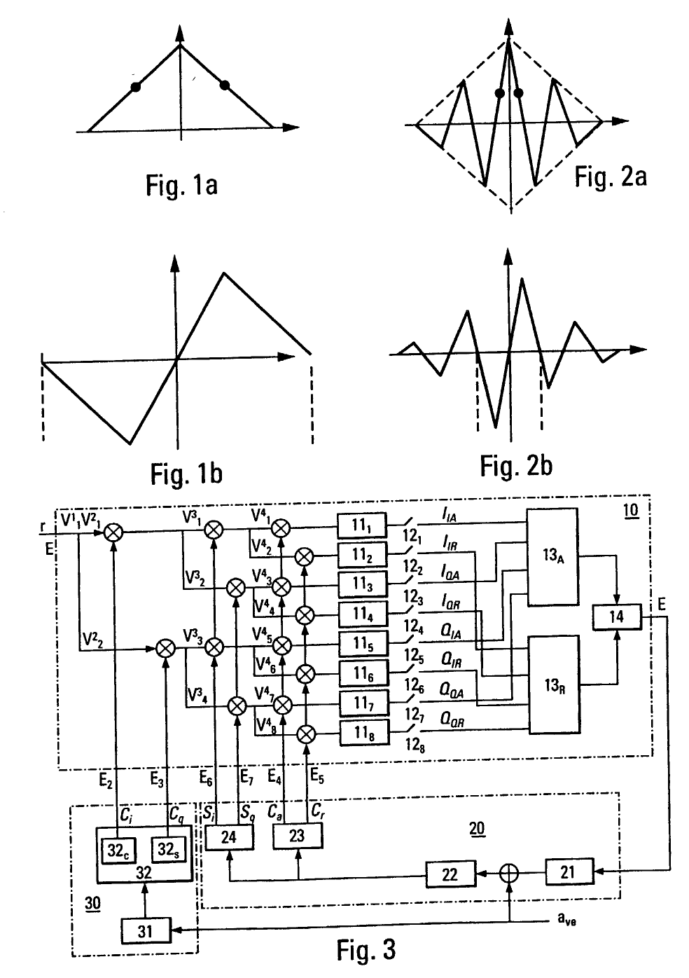

The carrier loop is generally a PLL (Phase Lock Loop), for example the Costa loop. The code loop generally includes a double correlation in order to evaluate the shift between the local code and received code which corresponds to a measurable energy difference, as shown on FIG. 1a for BPSK modulation. First, code phase correlation is used to slave the carrier loop. The difference of the I code correlations in advance and in lag is used to slave the code loop. This difference, called the discriminant function, is represented by FIG. 1b for BPSK modulation.

The receiver uses these two loops to obtain accurate, unambiguous measurements. In an initial phase, called the acquisition phase, the receiver operates in open loop to seek the received signal by testing several assumptions regarding the position and speed of the local code and the local carrier. Once the code loop has removed the possibility of ambiguity, the receiver operates in closed loop. The carrier loop provides its accurate measurements and the code loop is used for tracking.

If the signal to noise ratio is low, for example in the event of jamming, the carrier loop is the first to disconnect. If the receiver has an external speed aid, it can continue to operate in Code Only, i.e. with the code loop only, unaided by the carrier loop.

Generally, the modulation used in the satellite radionavigation systems is BPSK (Binary Phase Shift Keying) modulation. Another modulation: BOC (Binary Offset Chip) modulation, may be preferred since it offers a different use of the available band. For example, in military applications, it can be used to save energy when the band used by BPSK modulation is jammed. For civilian applications, it makes the system compatible with American systems which use different bands. In addition, with BOC modulation, the receiver performance is better since the spectrum is wider.

FIGS. 2a and 2b represent respectively the self-correlation function and the discriminant function for BOC modulation.

The disadvantage of BOC modulation is that the tracking receiver is less robust in Code Only mode than when BPSK modulation is used. The code self-correlation function which determines the stable equilibrium (or capture) areas of the code loop is also modulated by the subcarrier. This modulation reduces the central capture area and, consequently, increases the likelihood of disconnecting from the slaving on leaving this area. Disconnection is due to noise or dynamic trailing.

### PURPOSE OF THE INVENTION

This invention makes the receiver for Code Only mode in tracking more robust not only with BOC modulation but with any modulation involving one or more subcarriers.

The invention consists in the fact that the method used to track satellite radionavigation signals modulated by modulation with one or more subcarriers in reception comprises the elimination of the subcarrier(s).

### DESCRIPTION

The advantages and features of the invention will be clearer on reading the following description, given as an example, illustrated by the attached figures representing in:

FIGS. 1a and 1b respectively the self-correlation function and the discriminant function for BPSK modulation,

FIGS. 2a and 2b respectively the self-correlation function and the discriminant function for BOC modulation.

FIG. 3, device to track BOC modulated radionavigation signals according to the invention,

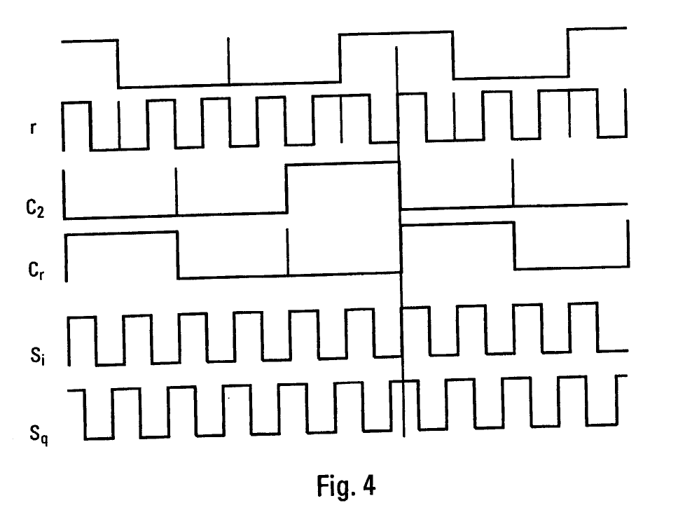

FIG. 4, representation of the code at various points of the device represented on FIG. 3,

FIG. 3 shows an example of the signal tracking device according to the invention. This device uses elimination of the BOC modulation subcarrier to make the tracking of the received radionavigation signal more robust in Code Only mode.

It includes a discriminant function computation device 10. This device 10 has seven inputs E1 to E7 and one output S. It receives the signal r from the satellite on the first input E1. The first input E1 forms the primary channel V¹₁ which is divided into two parallel identical secondary channels V²₁ and V²₂.

The first secondary channel V²₁ is multiplied by the carrier in phase cᵢ of the second input E2. The second secondary channel V²₂ is multiplied by the carrier in quadrature c_{q} of the third input E3. Each of these secondary channels V²₁ and V²₂ is divided into two parallel ternary channels V³₁ to V³₄.

The first ternary channel V³₁ resulting from the first secondary channel V²₁ is multiplied by the subcarrier in phase si of the sixth input E6. The second ternary channel V³₂ resulting from the first secondary channel V²₁ is multiplied by the subcarrier in quadrature s_{q}. The third ternary channel V³₃ resulting from the second secondary channel V²₂ is multiplied by the subcarrier in phase s_{I} of the sixth input E6. The fourth ternary channel V³₄ resulting from the second secondary channel V²₂ is multiplied by the subcarrier in quadrature s_{q} of the seventh input E7. Each of the ternary channels V³₁ to V³₄ is divided into two parallel quaternary channels V⁴₁ to V⁴₈.

The first quaternary channel V⁴₁ resulting from the first ternary channel V³₁ is multiplied by the phase advance code cₐ of the fourth input E4. The second quaternary channel V⁴₂ resulting from the first ternary channel V³₁ is multiplied by the phase lag code c, of the fifth input E5. The third quaternary channel V⁴₃ resulting from the second ternary channel V³₂ is multiplied by the phase advance code cₐ of the fourth input E4. The fourth quaternary channel V⁴₄ resulting from the second ternary channel V³₂ is multiplied by the phase lag code cᵣ of the fifth input E5. The fifth quaternary channel i V⁴₅ resulting from the third ternary channel V³₃ is multiplied by the phase advance code cₐ of the fourth input E4. The sixth quaternary channel V⁴₆ resulting from the third ternary channel V³₃ is multiplied by the phase lag code cᵣ of the fifth input E5. The seventh quaternary channel V⁴₇ resulting from the fourth ternary channel V³₄ is multiplied by the phase advance code cₐ of the fourth input E4. The eighth quaternary channel V⁴₈ resulting from the fourth ternary channel V³₄ is multiplied by the phase lag code cᵣ of the fifth input E5.

On each quaternary channel V⁴₁ to V⁴₈, the signals so obtained are processed by an integrate and dump device 11₁ to 11₈ which produces non-spread and cumulated samples. The signal I_{IA} of the first quaternary channel V⁴₁ is formed by the cumulated samples in phase for the carrier, in phase for the subcarrier and in phase advance for the code. The signal, I_{IR} of the second quaternary channel V⁴₂ is formed by the cumulated samples in phase for the carrier, in phase for the subcarrier and in phase lag for the code. The signal I_{QA} of the third quaternary channel V⁴₃ is formed by the cumulated samples in phase for the carrier, in quadrature for the subcarrier and in phase advance for the code. The signal I_{QR} of the fourth quaternary channel V⁴₄ is formed by the cumulated samples in phase for the carrier, in quadrature for the subcarrier and in phase lag for the code. The signal Q_{IA} of the fifth quaternary channel V⁴₅ is formed by the cumulated samples in quadrature for the carrier, in phase for the subcarrier and in phase advance for the code. The signal Q_{IR} of the sixth quaternary channel V⁴₆ is formed by the cumulated samples in quadrature for the carrier, in phase for the subcarrier and in phase lag for the code. The signal Q_{QA} of the seventh quaternary channel V⁴₇ is formed by the cumulated samples in quadrature for the carrier, in quadrature for the subcarrier and in phase advance for the code. The signal Q_{QR} of the eighth quaternary channel V⁴₈ is formed by the cumulated samples in quadrature for the carrier, in quadrature for the subcarrier and in phase lag for the code.

Thus, all the signals in phase advance for the code are standardised and summed by device 13_{A} to form I_{IA}²+I_{QA}²+Q_{IA}²+Q_{QA}² on one channel and all the signals in phase lag for the code are standardised and summed by device 13_{R} to form I_{IR}²+I_{QR}²+Q_{IR}²+Q_{QR}² on another channel. A code discriminator 14 receives two energies and divides the difference of the advance energy and the lag energy by their sum ε=(I_{IA}²+IA²+Q_{IA}²+Q_{QA}²−(I_{IR}²+I_{QR}²+Q_{IR}²+Q_{QR}²))/(I_{IA}²+I_{QA}²+Q_{IA}²+Q_{QA}²+I_{IR}²+Q_{IR}²+Q_{QR}²).

This discrimination information c is used by the code corrector 21. The code correction information produced by this corrector 21 is added using the external speed aᵥₑ and used by the code oscillator 22 of the code loop 20, for example a numerical controlled oscillator (NCO). This oscillator 22 controls the code replica generator 23 and the BOC subcarrier replica generator 24.

The code replica generator 23 provides the phase advance code cₐ replica coupled on the fourth input E4 of the discriminant function computation device 10 and the phase lag code cᵣ replica coupled on the fifth input E5 of the discriminant function computation device 10. The subcarrier replica generator 24 provides the subcarrier in phase sᵢ replica coupled on the sixth input E6 of the discriminant function computation device 10 and the subcarrier in quadrature S_{q} replica coupled on the seventh input E7 of the discriminant function computation device 10.

In the carrier loop 30, the carrier oscillator 31, e.g. an NCO, receives the external speed aid aᵥₑ in Code Only mode. It checks the carrier replica generator 32. This carrier replica generator 32 may, for example, include a sine function 32_{S} and a cosine function 32_{C}. One of these functions generates the carrier in phase cᵢ replica coupled to the input E2 of device 10 and the other the carrier in quadrature c_{q} replica coupled to the input E3 of device 10.

FIG. 4 shows firstly the code received without BOC modulation on the first line, and the code received with BOC modulation r by the tracking device of FIG. 3 on the second line. The third and fourth lines illustrate the code replicas, respectively in phase advance cₐ and phase lag cᵣ, generated by the device 23 and coupled to inputs E4 and E5 of the discriminant function computation device 10. The fifth and sixth lines illustrate the BOC subcarrier replicas, respectively in phase sᵢ and quadrature s_{q}, generated by the device 24 and coupled to inputs E6 and E7 of the discriminant function computation device 10.

This method of eliminating the subcarrier to compute the discriminant function can be used for any modulation with a subcarrier and for any type of application involving the computation of this discriminant function. The use in the context of BOC modulation and for radionavigation signal tracking is only an example of how the invention can be used.

In addition, this method of eliminating the subcarrier by multiplying by the subcarrier replica in phase and in quadrature can be used more than once when the particular modulation is modulation with several subcarriers and not just one.

1. Method to compute the discriminant function of signals modulated by modulation with one or more subcarriers, wherein it comprises elimination of said subcarrier(s).

2. Device to compute the discriminant function of BOC modulated signals comprising a first input for the received signals, a second input and a third input for coupling of said discriminant function computation device with the carrier generator, one in phase, the other in quadrature, a fourth input and a fifth input for coupling of said discriminant function computation device with the code generator, one in advance, the other in lag, and an output for the discriminant function, wherein it comprises the elimination of the subcarrier.

3. Discriminant function computation device according to the previous claim, wherein it comprises a sixth input and a seventh input for coupling of said discriminant function computation device with the subcarrier generator, one in phase, the other in quadrature.

4. Discriminant function computation device according to claim 2 or 3, wherein the discriminant function is equal to the difference between the energy in phase advance and the energy in phase lag: (I_{IA}²+I_{QA}²+Q_{IA}²+Q_{QA}²−(I_{IR}²+I_{QR}²+Q_{IR}²+Q_{QR}²))/(I_{IA}²+I_{QA}²+Q_{IA}²+Q_{QA}²+I_{IR}²+I_{QR}²+Q_{IR}²+Q_{QR}²).

5. Device to track BOC modulated satellite radionavigation signals in reception comprising:
a first input receiving the received signal,
a second input receiving external speed aid,
a discriminant function computation device whose first input is coupled to the first input of said receiver,
a code corrector coupled to the output of said discriminant function computation device,
a carrier loop coupled to the second input of said receiver,
a sine function and a cosine function coupled to the output of the carrier loop to obtain the carrier in phase and in quadrature coupled to the second and third inputs of said discriminant function computation device,
a code loop receiving the output of the code corrector to which the external speed aid has been added,
a code generator coupled to the output of the code loop and to the fourth and fifth inputs of said discriminant function computation device,
wherein:
said discriminant function computation device is the device according to claim 2 or 3, and wherein
said receiver comprises a subcarrier generator coupled to the output of the code loop and to the sixth and seventh inputs of said discriminant function computation device,

6. Method to track BOC modulated satellite radionavigation signals in reception, wherein it comprises the elimination of the subcarrier.
